(19) United States
(12) Patent Application Publication
(10) Pub. No.: US 2010/0006619 A1
(43) Pub. Date: Jan. 14, 2010

(54) Fastener Positioning Assembly for Nail Gun

(76) Inventors: Chia-Sheng LIANG, Taipei Hsien (TW); I-Tsung Wu, Taipei Hsien (TW); Yi-Hui Chen, Taipei Hsien (TW)

Correspondence Address: HDLS Patent & Trademark Services, P.O. BOX 220746, CHANTILLY, VA, 20153-0746, US

(21) Appl. No.: 12/168,894

(22) Filed: Jul. 8, 2008

(51) Int. Cl. B25C 1/04

(52) U.S. Cl. 227/130

(57) ABSTRACT

A nail gun includes a fastener drive track capable of receiving fasteners having different length. A faster positioning assembly includes at least one swinging member and a stop portion. The swinging member is elastically and pivotably disposed at a side of the fastener drive track. The stop portion is formed at an end of the swinging member and received in the fastener drive track. The stop portion is configured for positioning fasteners prior to the fasteners are hit, and the stop portion retractably exits from the fastener drive track when a long fastener is received in the fastener drive track. The fastener positioning assembly enables the nail gun to drive fasteners having different length, as such, it is very convenient to use such nail gun to join different workpiece having different thickness on an object.

### BACKGROUND

1. Field of the Invention

The present invention generally relates to a fastener positioning assembly for pneumatic nail gun, and more particularly, to a fastener positioning assembly that can positioning long fasteners and short fasteners in one nail gun.

2. Discussion of Related Art

Currently, when a user try to join a workpiece having a preformed through hole (for example, a gasket) on an object using a pneumatic nailer, in order to join at right position, a fastener (for example, a nail) must be aligned with the through hole. Therefore, a nailer that exposes a tip of the fastener is developed to simplify the alignment operation.

In addition, different workpieces have different thickness. In order to provide ability of automatically detecting workpieces that are in predetermined thickness range in pneumatic nailers, conventionally, a safety rod is installed in a main passageway that connects a trigger valve and a main valve. The safety rod includes a positioning member formed at a bottom end thereof. When the safety rod reaches a predetermined height above the object, a control valve is opened. The control valve conducts pressurized air to open the main valve; as a result, the pressurized air is conducted to drive a drive rod to hit the fastener. The predetermined height includes a thickness of the workpiece or a depth of the through hole. The user can place a tip of the fastener that is exposed from a drive track exit in the through hole. The tip is in contact with a surface of the object. The positioning member is sustained by the workpiece; the depth of the through hole is reflected by a relative distance between the tip of the fastener and the positioning member. When a height of the positioning member is in a predetermined range, the control valve is opened, the pressurized air is conducted to switch the main valve to an open state, and then the pressurized air drives the drive rod to hit the fastener.

In addition, pneumatic nailers including driving control mechanism that is similar to the control valve have also been disclosed in the art, for example, US Patent Publication Number 2007/007513, in which a swinging pole that is driven by the safety rod and a valve stem are employed. The valve stem can be sustained and released by the swinging pole; as a result, the main valve is controlled. In other words, the action of the nailer is also controlled.

However, in order to correctly detect the depth of the through hole, the length of the fasteners is predetermined. In other words, the above nail gun can only process fasteners having a same length. When the user try to use the above nail gun to drive a short fastener, the short fastener can't be rightly positioned and a tip of the short fastener can not be exposed from the drive track exit. The short fastener can't be aligned with the through hole. Thus, the short fastener can't be successfully hit into the object.

### BRIEF SUMMARY

The present invention provides a fastener positioning assembly, and more particularly, the present invention provides a nail gun, such as a pneumatic nailer, which includes control valve for controlling action of the nail gun. The nail gun further includes a trigger valve that is capable of driving a valve stem of the control valve and a safety rod installed in the nail gun to move downwardly. When the safety rod reaches a position of predetermined height the control valve controls pressurized air to drive a drive rod to hit fasteners. In addition, a fastener positioning assembly is also installed on the nail gun. The fastener positioning assembly is configured for automatically and correctly positioning fasteners having different length such that the tip of different fasteners can be exposed from a drive track exit defined in the nail gun.

In one exemplary embodiment, a fastener positioning assembly for being installed on a housing of a nail gun. The nail gun includes a fastener drive track that is capable of receiving fasteners having different length. The faster positioning assembly includes at least one swing member elastically and pivotably disposed at a side of the fastener drive track; and a stop portion defined at an end of the swing member and received in the fastener drive track, the stop portion is configured for restricting position of the short fasteners prior before the fasteners are driven, and the stop portion retractably exit from the fastener drive track when longer fasteners are received in the fastener drive track.

When short fastener is received in the fastener drive track, the shot fastener can be positioned such that the tip thereof is exposed from the drive track exit, the short fastener can be also driven by the nail gun. Thus, it is very convenient that the nail gun can selectively use different fasteners according to different requirements.

In addition, a trigger valve can be employed in the nail gun. The trigger valve is configured for conducting the pressurized air to drive the valve stem and the safety rod to move downwardly. Alternatively, the trigger valve moves downwardly together with the safety rod and the valve stem.

In another exemplary embodiment, a contact portion is formed on an end of the swinging member, the contact portion extends into a feed track disposed at a side of the fastener drive track, the contact portion is configured for driving the stop portion to retractably exit from the fastener drive track when the fasteners are hit. As a result, the stop portion is protected from being hit by a head of the long fastener.

In still another exemplary embodiment, the fastener positioning assembly includes two swinging members. The two swinging members are respectively pivotably disposed at two opposite sides of the fastener drive track, an elastic member connects the two swinging members to each other, and the elastic member provides an elastic force to drive the stop portion to enter the fastener drive track.

In still another exemplary embodiment, an end groove is defined in an end of the housing that is adjacent to the swinging member, the end groove is connected to the fastener drive track and opposite to the stop portion, the end groove is configured for allowing the stop portion retractably exit therefrom.

In still another exemplary embodiment, another end groove can also be defined in the end of the housing that is adjacent to the swinging member, the end groove is connected to the feed track and opposite to the contact portion; the contact passes through the end groove and enters the feed track. It is to be understood that the end groove opposite to the stop portion and the end groove opposite to the contact portion can be a same end groove, or two respective end grooves.

In another exemplary embodiment, the swinging member includes a connecting portion configured for pivotably mounting the swinging member at the side of the fastener drive track; the contact portion is arranged between the connecting portion and the stop portion.

In another exemplary embodiment, a lug portion is formed on the swinging member, the lug portion is adjacent to the stop portion, and the lug portion is configured for sustaining on the housing when the stop portion is received in the fastener drive track thereby controlling a depth of the stop portion in the fastener drive track. As a result, the stop portion is protected from being hit by a drive rod.

The present invention will be described in detail as following:

### BRIEF DESCRIPTION OF THE DRAWINGS

These and other features and advantages of the various embodiments disclosed herein will be better understood with respect to the following description and drawings, in which like numbers refer to like parts throughout, and in which:

FIGS. 1 and 1a are perspective schematic views of the first embodiment;

FIGS. 2 and 2a are perspective schematic views of a swinging member in FIG. 1;

FIG. 3 is a cross sectional schematic view of the first embodiment;

FIG. 4 is a partially enlarged view of FIG. 3;

FIG. 5 is a schematic view showing a configuration of a safety rod;

FIG. 5a is a schematic view showing an end groove;

FIG. 6 is a cross sectional view of a fore-end passageway;

FIG. 7 is a cross sectional view of a back-end passageway;

FIG. 8 is a schematic view of a valve bush;

FIG. 9 is a schematic view showing a long fastener is received in the fastener drive track;

FIG. 10 is a schematic view showing a configuration of the swinging member and the long fastener;

FIG. 11 is schematic view showing operation procedure of the swinging member and a positioning member;

FIG. 11a is an another schematic view showing successive operation procedure of the swinging member and the positioning member;

FIG. 12 is still an another schematic view showing successive operation procedure of the swinging member and the positioning member;

FIG. 13 is a schematic view illustrating operation procedure of FIG. 4;

FIG. 14 is a schematic view illustrating operation procedure of FIG. 3;

FIG. 15 is another schematic view illustrating operation procedure of FIG. 4;

FIG. 16 is another schematic view illustrating operation procedure of FIG. 3;

FIG. 17 is still an another schematic view illustrating operation procedure of FIG. 4;

FIG. 18 is yet another schematic view illustrating operation procedure of FIG. 4;

FIG. 19 is a cross sectional view showing short fastener is received in the fastener drive track;

FIG. 20 is a schematic view showing a configuration of the swinging member and the short fastener;

FIG. 21 is an another schematic view illustrating operation procedure of the swinging member and the positioning member;

FIG. 22 is a schematic view illustrating successive operation procedure of FIG. 21;

FIG. 23 is a perspective schematic view of a swinging member in accordance with the second embodiment;

FIG. 24 is a schematic view showing a configuration of the swinging member;

FIG. 25 is still another schematic view illustrating operation procedure of the swinging member and the positioning member; and

FIG. 26 is still another schematic view illustrating successive operation procedure of FIG. 25.

### DETAILED DESCRIPTION

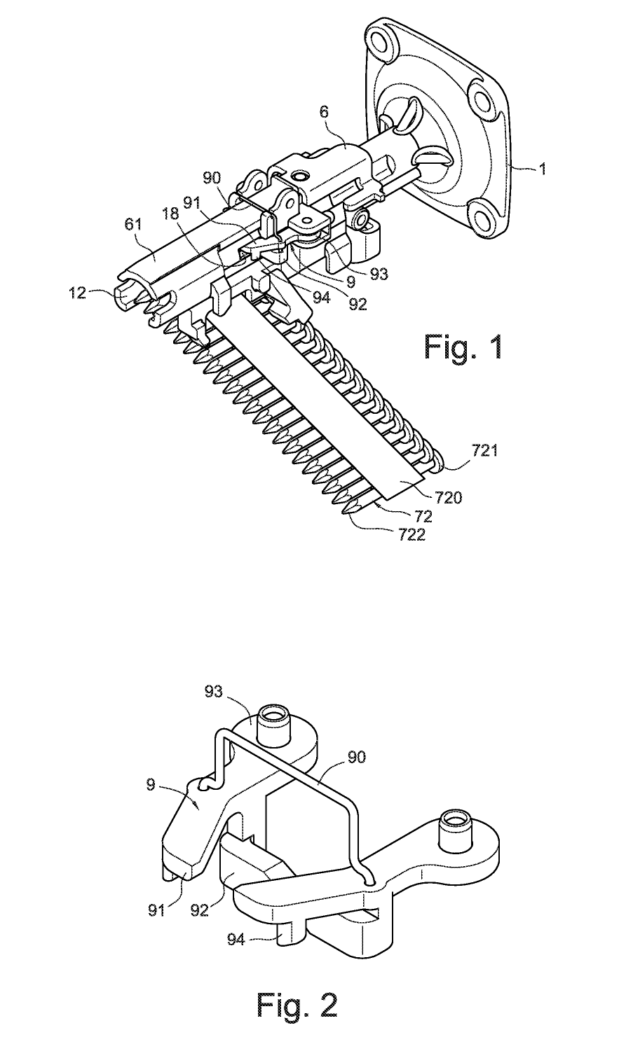

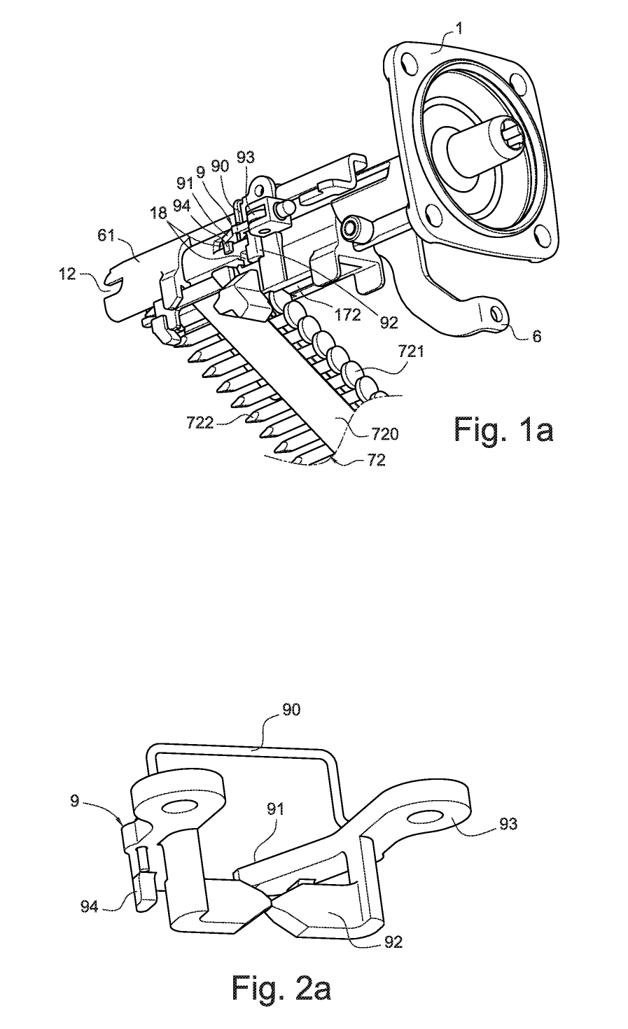

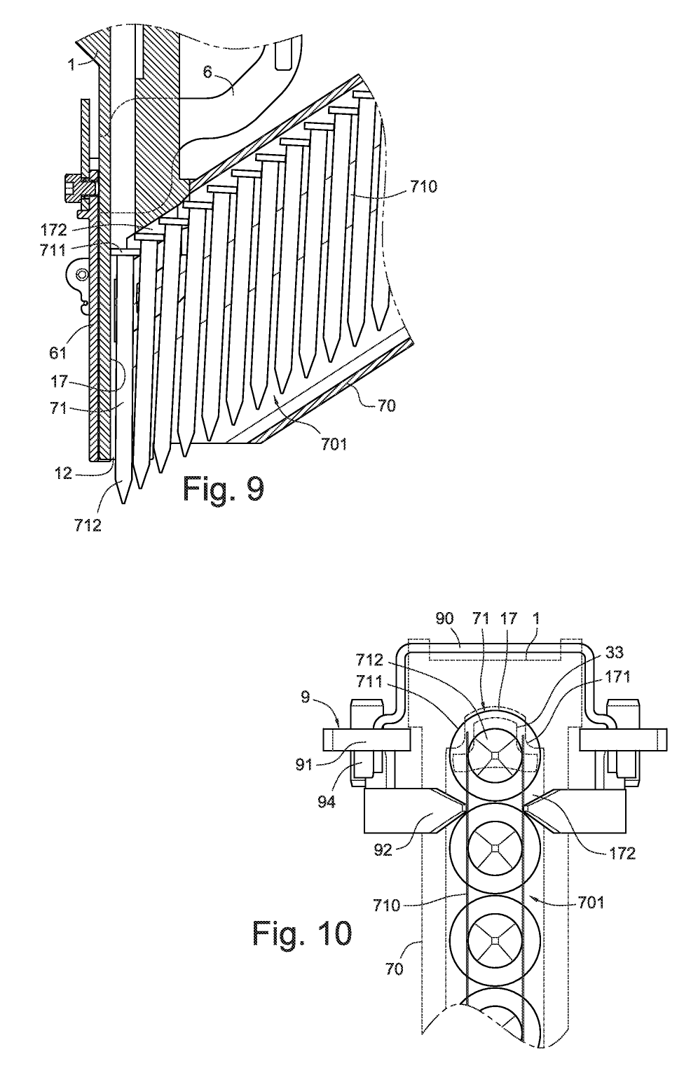

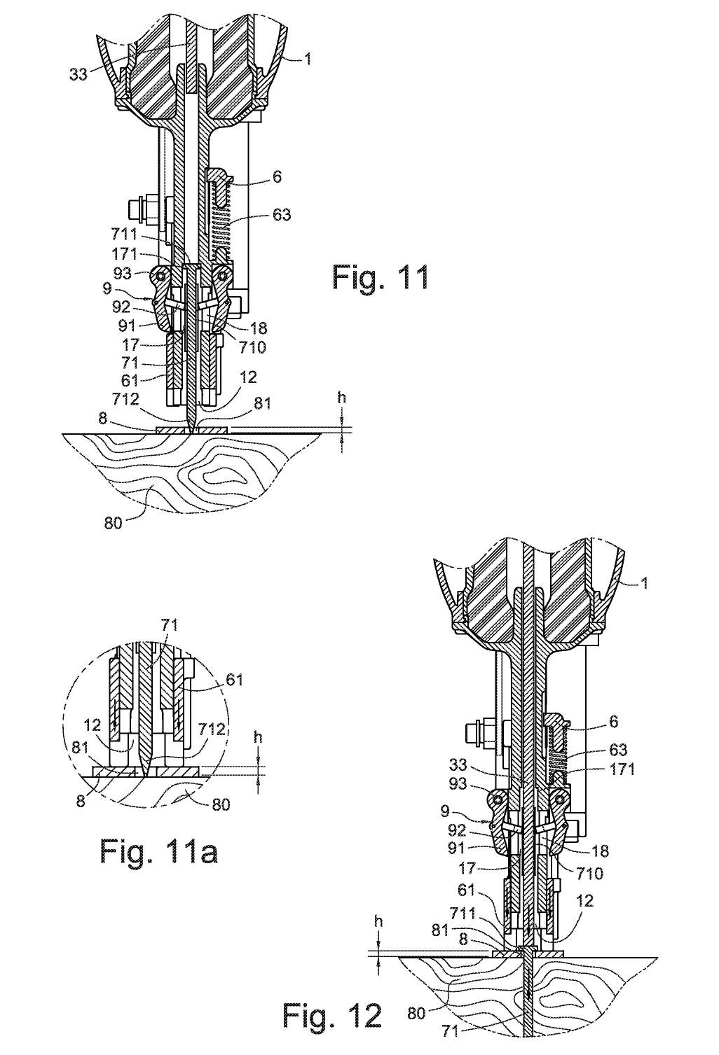

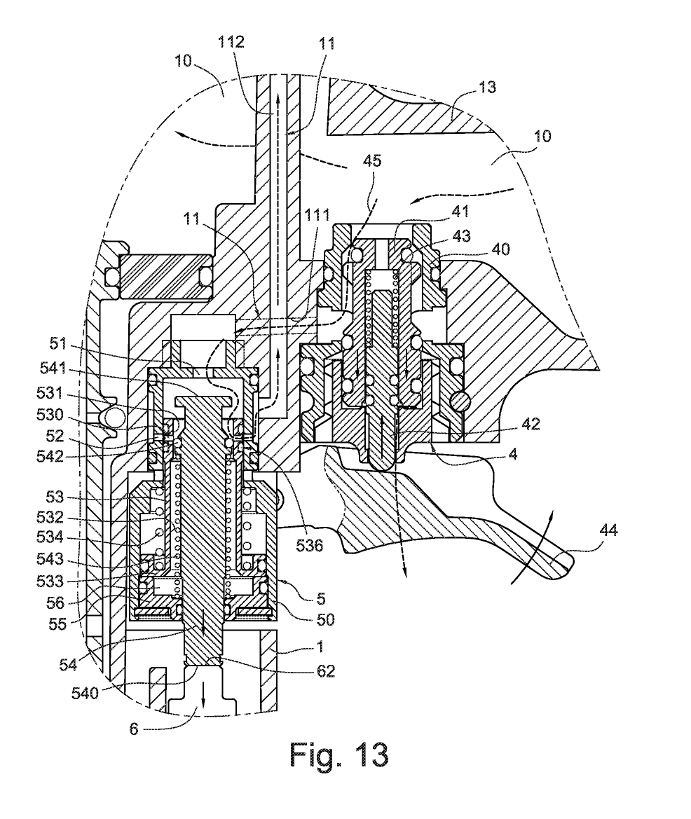

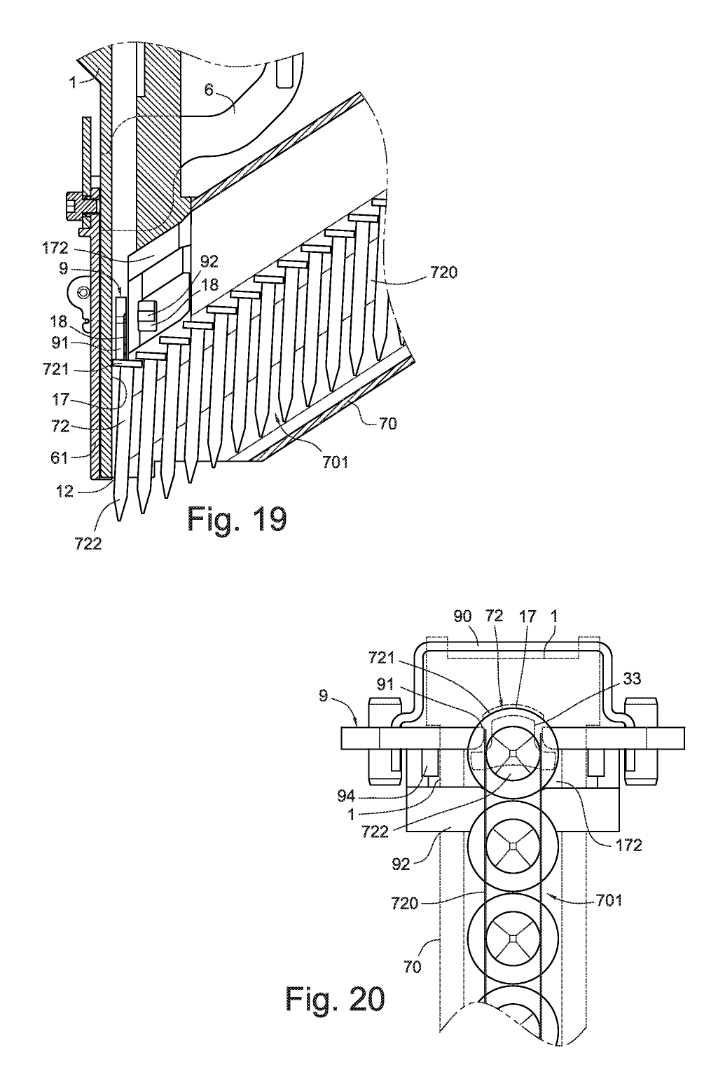

Referring to FIG. 1 together with FIGS. 1a, 2, 2a and 3, a fastener positioning assembly in accordance with an embodiment is illustrated. The fastener positioning assembly includes a fastener drive track 17 located at a bottom of a housing 1 of a nailer (as shown in FIGS. 9 and 19). The fastener drive track 17 is capable of receiving fasteners having different length, for example, long fasteners 71 as shown in FIG. 9 and short fasteners 72 as shown in FIG. 19. Each of the long fasteners 71 includes a head 711 and a tip 712. Each of the short fasteners 72 includes a head 721 and a tip 722. At least one step portion 171 is formed in the fastener drive track 17. In the present embodiment, two step portions 171 (as shown in FIG. 10) are formed in the fastener drive track 17. The two step portions 171 can stop the head 711 of long fastener 71 and expose the tip 712 of the long fastener 71 from a driver track exit 12. A control valve 5, which includes a body 50 is installed in the housing 1. A solid valve stem 54 is slidably disposed in the body 50. The solid valve stem 54 is arranged on a predetermined position so as to push and sustain a safety rod 6 mounded on the housing 1 when the safety rod 6 moves downwardly. A trigger valve 4 is installed in the housing 1. The trigger valve 4 is configured for driving the valve stem 54 and the safety rod 6 to move downwardly. As shown in FIG. 13, in the present embodiment, the trigger valve 4 is capable of conducting pressurized air to drive the valve stem 54 of the control valve 5 and the safety rod 6 to move downwardly. At a same time, the control valve 5 is switched to an open state when a distal end of the safety rod 6 reach a predetermined height h (as shown in FIGS. 11, 12 and 14) thereby the pressurized air being conducted to drive the main valve 2 in the housing 1 to open, as a result, the nailer is powered to drive the fasteners.

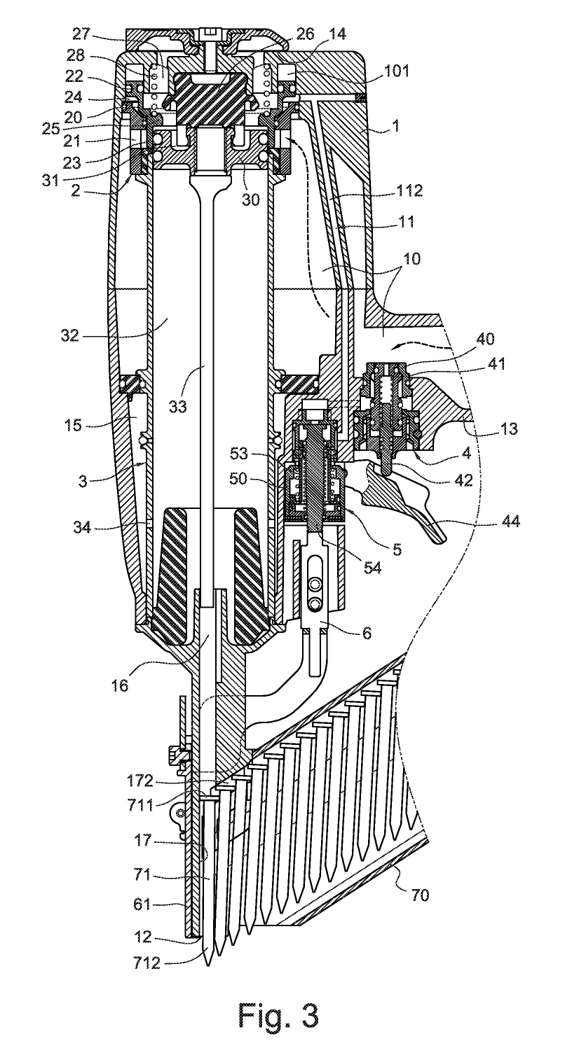

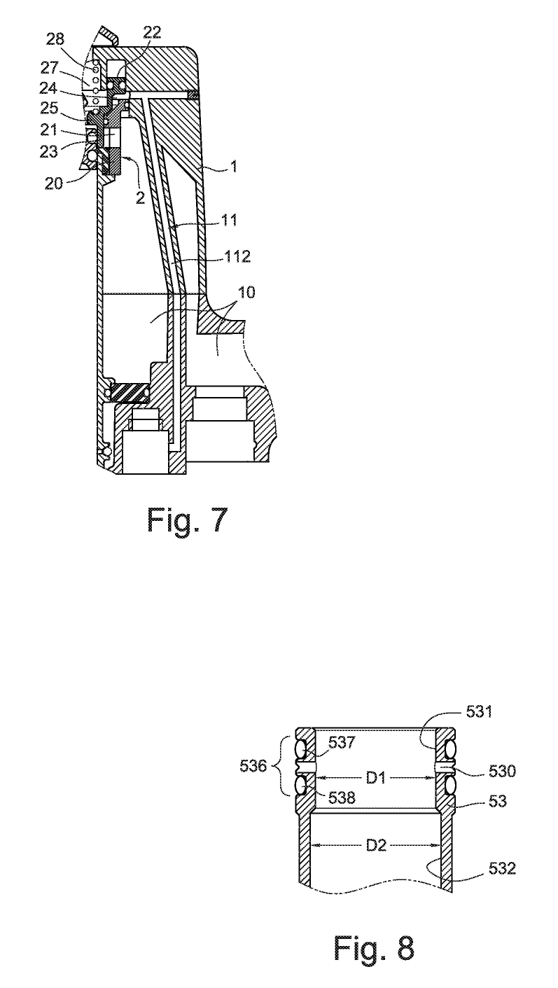

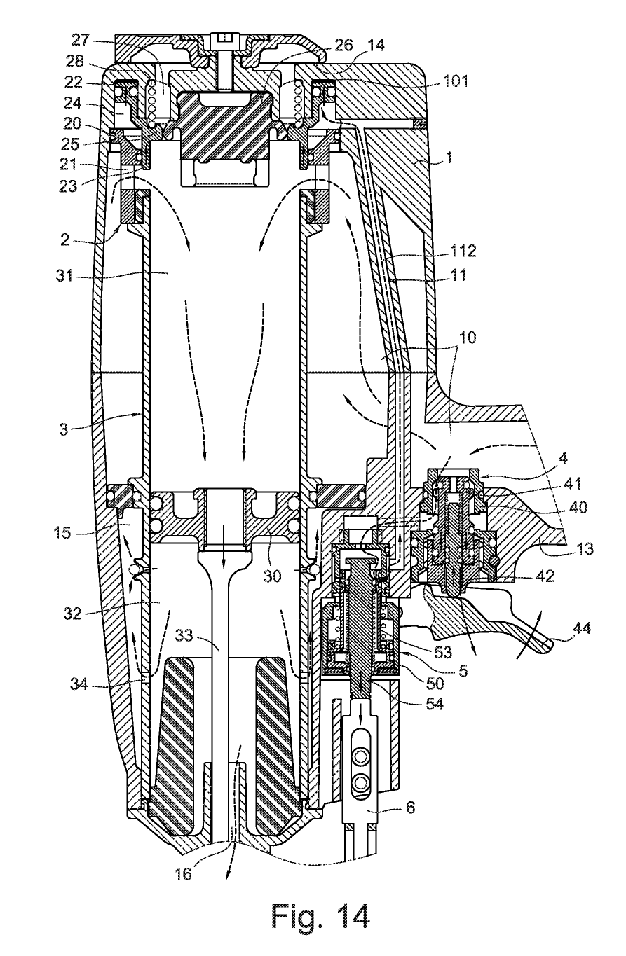

The housing 1 defines a reservoir 10 therein. A main passageway 11 (as shown in FIG. 3) connects the reservoir 10 to the main valve 2. The reservoir 10 contains pressurized air whose pressure is maintained at a constant level. The main valve 2 is disposed at a top end of a cylinder 3. The main valve 2 is configured for allowing or preventing the pressurized air in the reservoir 10 to enter the cylinder 3 under drive of the pressurized air in the main passageway 11 (referring to FIG. 14). The trigger valve 4 connected to the main passageway 11 in series. The trigger valve 4 is configured for conducting the pressurized air contained in the reservoir 10 to pass through the main passageway 11 and the control valve 5, and finally switch the main valve 2 to an open state thereby power the nailer to drive fasteners. The safety rod 6 is slidably mounted on the housing 1 and a positioning member 61 is defined at a bottom end thereof (referring to FIGS. 11 and 12). The positioning member 61 extends beyond the fastener drive track exit 12 of the housing 1, and is configured for engaging with a workpiece 8. The control valve 5 is in serious connection with the main passageway 11 between the trigger valve 4 and the main valve 2 thereby dividing the main passageway 11 into a fore-end passageway 111 (referring to FIG. 6) and a back-end passageway 112 (referring to FIG. 7). The fore-end passageway 111 is connected to the trigger valve 4 and the reservoir 10; and the back-end passageway 112 is connected to the main valve 2.

A feed groove 172 is defined at one side and near to a distal end of the fastener drive track 17 (as shown if FIGS. 1a, 3, 9 and 10), and a magazine assembly 70 receiving a number of long fasteners 71 and a number of short fasteners 72 therein is installed adjacent to the feed groove 172 (as shown in FIGS. 9,10,19 and 20). [symbol] [symbol] A handle 13 is formed on the housing 1, and the reservoir 10 is defined in the housing 1 and the handle 13. The reservoir 10 is located at outer side of the main valve 2 and the cylinder 3. The main valve 2 includes a body 20, a number of holes 21 in communication with the cylinder 3 are defined in an outer surface of the body 20. A valve bush 22 is slidably mounted in a top end (i.e. the end that adjacent to the back-end passageway 112) of the body 20. An annular upper chamber 101 connecting to the reservoir 10 is defined between the inner sidewall of the housing 1 and the top end of the valve bush 22, and an annular lower valve portion 23 is defined at a bottom end of the valve bush 22. The lower valve portion 23 extends into the body 20 and plugs the holes 21. The upper chamber 101 is configured for gathering pressurized air to drive the valve bush 22 to move downwardly (i.e. close to the cylinder 3) thereby plugging the holes 21 with the lower valve portion 23. A main chamber 24 is defined between the valve bush 22, the body 20 and the inner sidewall of the housing 1. The main chamber 24 is connected to the back-end passageway 112. The main chamber 24 is configured for gathering pressurized air from the back-end passageway 112 to drive the valve bush 22 to move upwardly (i.e. away from the cylinder 3) thereby opening the holes 21 (referring to FIG. 14). The main valve 2 includes a valve core 26 disposed on an inner sidewall of the housing 1 and above the cylinder 3. The valve bush 22 surrounds the valve core 26, in other words, the valve core 26 is disposed in the valve bush 22. A vent hole 14 is defined in a top end (i.e. the end adjacent to the valve bush 22) of the housing 1. A vent passageway 27 is defined between the valve bush 22 and the valve core 26. The vent passageway 27 connects an inner chamber of the cylinder 3 to the vent hole 14. An annular upper valve portion 25 is formed in the inner sidewall o the valve bush 22. A compressed third spring 28 is disposed in the vent passageway 27. Two ends of the third spring 28 are respectively pressed by the upper valve portion 25 and the inner sidewall of the housing 1. The third spring 28 is configured for assisting the pressurized gas in the upper chamber 101 to drive the valve bush 22 to move downwardly, at a same time, the upper valve portion 25 is in tightly contact with the valve core 26 and then vent passageway 27 is thereby closed.

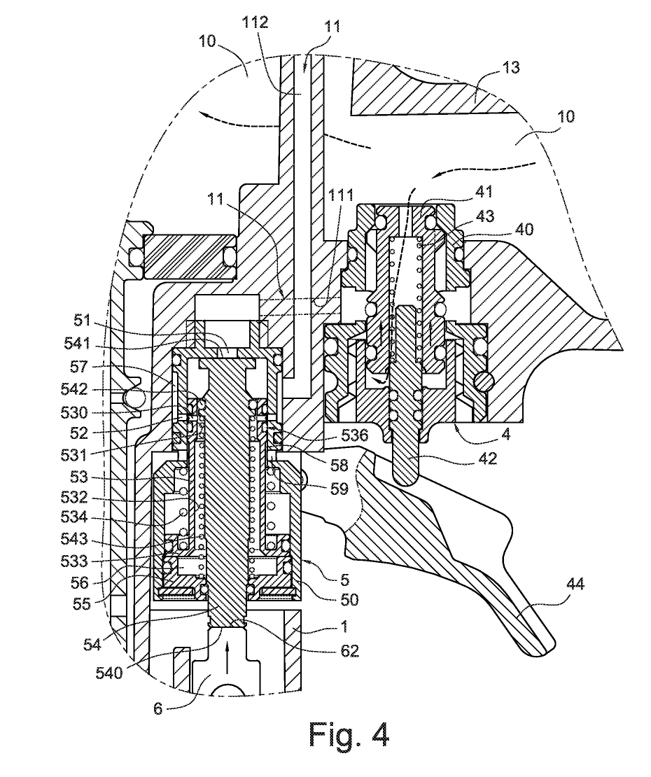

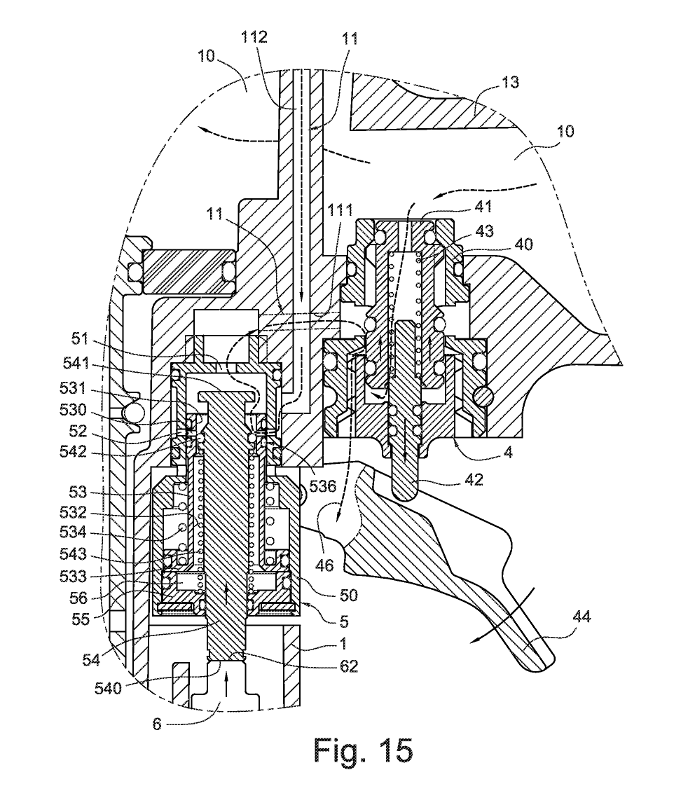

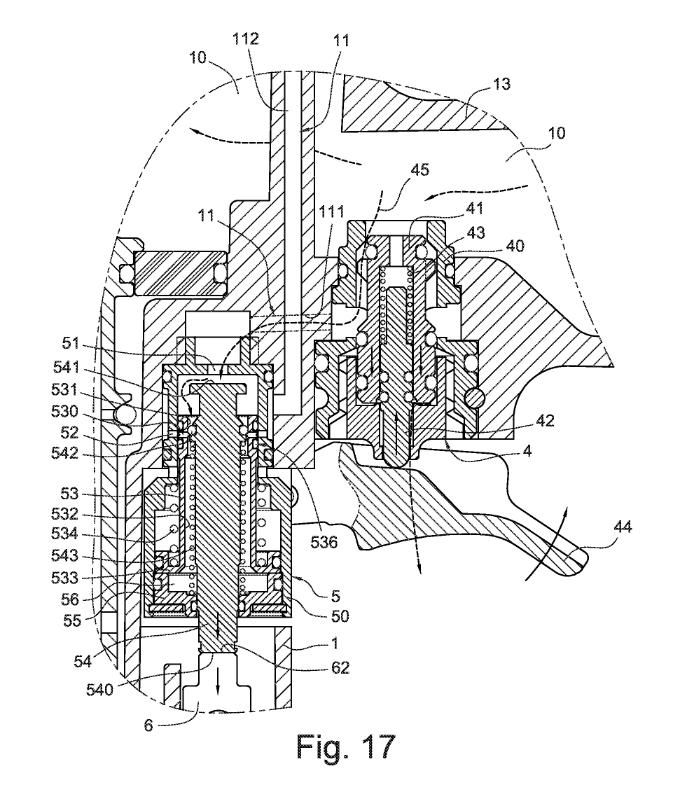

As shown in FIG. 3, a piston 30 is slidably disposed in the cylinder 3. The piston 30 divides the inner chamber of the cylinder 3 into an upper cylinder chamber 31 and a lower cylinder chamber 32. The upper cylinder chamber 31 is connected to the vent passageway 27. A drive rod 33 is fixed to a bottom side (i.e. the side adjoining the lower cylinder chamber 32) of the piston 30. A back air chamber 15 is defined between the outer surface of the cylinder 3 and the inner sidewall of the housing 1. A number of holes 34 are defined in the bottom end of the cylinder 3. The holes 34 connect the lower cylinder chamber 32 to the back air chamber. Referring to FIG. 4, the trigger valve includes a body 40; a poppet 41 is slidably installed in the body 40. A valve stem 42 is slidably received in the poppet 41. The valve stem 42 can be pressed or released. A fourth spring 43 is disposed between the poppet 41 and the valve stem 42. An end of the valve stem 42 is received in the fourth spring 43, and the other end is attached to a trigger 44 which is rotatably mounted on the housing 1. Referring to FIG. 13, the trigger 44 is configured for helping a user to drive the valve stem 42 to move upwardly. As shown in FIG. 15, when the trigger 44 is released the valve stem 42 will be reset by the fourth spring 43. In addition, referring to FIGS. 15 and 17, the trigger valve 4 defines an air passageway 45 and a vent passageway 46. The air passageway 45 is connected to the reservoir 10 and the main passageway 11, and the vent passageway 46 is connected to the main passageway 11 and the outer atmosphere.

Referring to FIG. 4, an air inlet 51 is defined at the top end of a body 50 of the control valve 5. The air inlet 51 is in communication with the trigger valve 4 through the fore-end passageway 111. An air outlet 52 is formed in a sidewall of the body 50. The gas outlet 52 is in communication with the main valve 2 through the back-end passageway 112. As shown in FIG. 8, a valve bush 52, which includes an upper neck hole 531 and a lower through hole 532 communicating with each other, is slidably received in the body 50. A diameter D2 of the through hole 532 is larger than a diameter D1 of the neck hole 531. The neck hole 531 is connected to the air inlet 51, and at least one hole 530 is formed in an inner sidewall of the neck hole 531. The hole 530 is connected to the air outlet 52. A lower chamber 56 is defined between the valve bush 53 and the inner sidewall of the body 50. The lower chamber 56 is connected to the through hole 532. The valve stem 54 is slidably received in the valve bush 53. A top end of the valve stem 54 defines a contact end surface 541 that is adjacent to the air inlet 51. When the contact end surface 541 is pressed by pressurized air and the valve stem 54 will move downwardly. A bottom end of the valve stem 54 extends to a top end 62 of the safety rod 6 and defines a contact surface 540 that is in contact with the top end 62. Referring to FIGS. 13 and 15, the safety rod 6 will move downwardly when the contact surface 540 applies force on the top end 62, and the safety rod 6 will go back its original position when the contact surface 540 is released from the top end 62. An annular gasket is disposed around the valve stem 54 thereby constitutes a valve plug 542 that is slidably received in the neck hole 531. The valve plug 542 is configured for preventing pressurized air to pass through the neck hole 531.

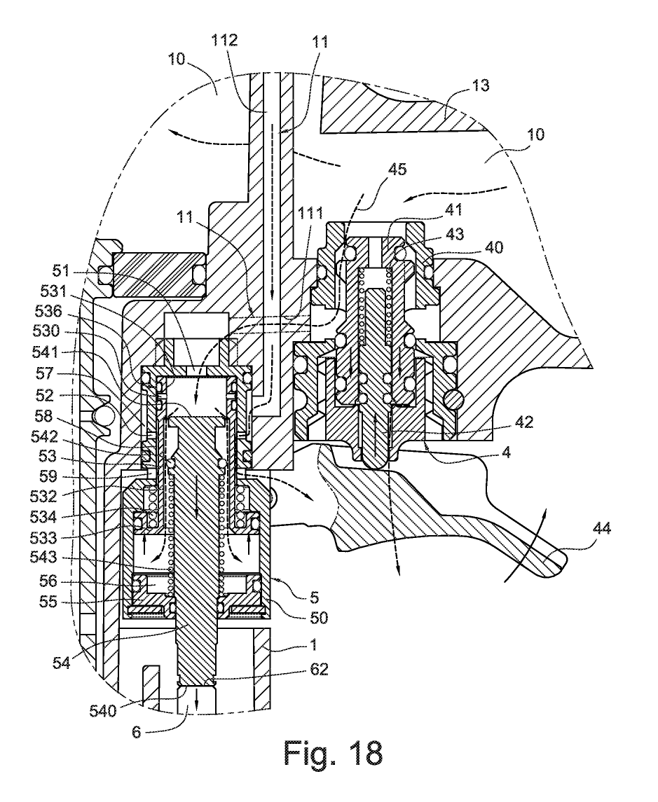

As shown in FIG. 4, a cover 55 is mounted on the bottom end of the body 50. The lower chamber 56 is defined between the bottom end of the valve bush 53 and the cover 55. Referring to FIG. 18, the lower chamber 56 is configured for gathering pressurized air from the fore-end passageway 111, air inlet 51, neck hole 531 and the through hole 532 to drive the valve bush 53 to move upwardly. An annular chamber 57 is defined around the outer sidewall of the body 50. The annular chamber 57 is connected to the air outlet 52 and the back-end passageway 112. Referring to FIGS. 4 and 8, a plug portion 536 is formed around the outer sidewall of the valve bush 53. The plug portion 536 is slidably received in the body 52, and is configured preventing pressurized air escape from the air outlet 52 and the hole 530 when the air outlet 52 is connected to the hole 530. In the present embodiment, the plug portion 536 includes two gaskets 537, 538 (these two gaskets are not indicated in the drawings). The hole 530 is located between the two gaskets 537, 538.

As shown in FIG. 4, an annular portion 533 extrudes from the bottom end of the valve bush 53. Outer sidewall of the valve bush 53 that is near to the air outlet 52, a top side of the annular portion 533 and the inner sidewall of the body 50 define an annular middle chamber 58 therebetween. A vent hole 59 is formed in the sidewall of the body 53 that is below the air outlet 52. The vent hole 59 connects the middle chamber 58 to outer atmosphere. Referring to FIG. 18, the valve bush 53 prevent the air inlet 51, the hole 530 from being in communication with the air outlet 52 when it is elevated, and simultaneously, the air outlet 52, the middle chamber 58 are in communication with the vent hole 59. The valve bush 53 is telescopically received in the body using a spring, specifically, an end of the valve bush 53 is received in a first spring 534, and two ends of the first spring 534 are respectively compressed by the inner sidewall of the body 50 and middle chamber 58. Thus, the valve bush 53 endures an elastic force from the first spring 534. It is to be understood that the pressurized air in the lower chamber 56 apply a force that is larger than the elastic force applied by the first spring to the valve bush 53.

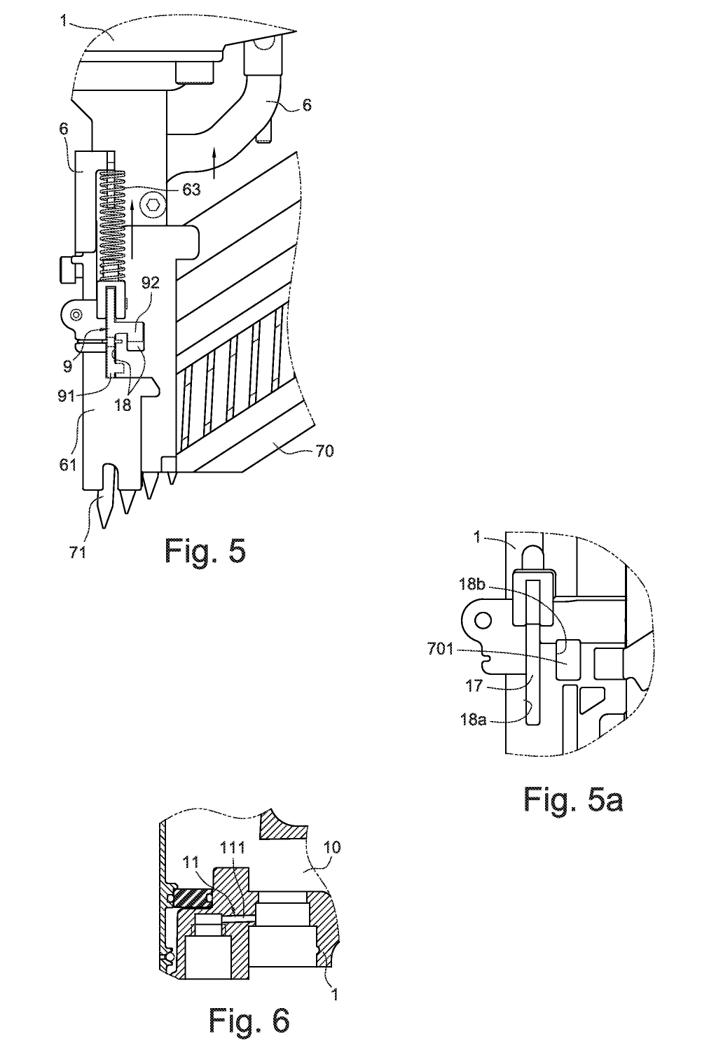

The valve stem 54 is telescopically received in the valve bush 53 by applying a spring on the valve stem 54. Referring to FIG. 4, an end of the valve stem 54 is received in the second spring 543. Two ends of the second spring 543 are respectively compressed by the valve plug 542 and the cover 55 such that the valve stem 54 is elastically supported by the second spring 543. The pressurized as in the gas inlet 51 apply a larger force onto the valve stem 54 than the second spring 543. As shown in FIGS. 5 and 11, a fifth spring 63 is disposed between the safety rod 6 and a bottom end of the housing 1. Referring to FIGS. 9 and 19, the fifth spring 63 is configured for driving the safety rod 6 together with the positioning member 61 to move upwardly till top end 62 of the safety rod get in contact with the contact surface 540 of the valve stem 54 of the valve stem 54 such that tips 712, 722 of the long fasteners 71 or short fasteners 72 received in the fastener drive track 17 are exposed from the drive track exit 12 and the positioning member 61.

According to above description, the present fastener positioning assembly includes a swinging member 9 and a stop portion 91. The swinging member 9 is elastically and pivotably mounted on a side (as shown in FIG. 11) of an end of the fastener drive track 17. In the present embodiment, the fastener positioning assembly includes two swinging members 9 respectively pivotably mounted on two opposite sides of the end of the fastener drive track 17. The stop portion 91 is formed at an end of the swinging member (as shown in FIGS. 1, 1a, 2, 2a, 11, and 21) and received in the fastener drive track 17. The stop portion 91 is configured for positioning short fasteners 72 received in the fastener drive track 17 prior to the short fasteners 72 are driven. The stop portion 91 exits from the fastener drive track 17 when long fasteners 71 are received in the fastener drive track 17.

In another specific embodiment, referring to FIGS. 10 and 20, a contact portion 92 is formed at one end of the swinging member 9, the contact portion 92 extends into a feed track 701 arranged at an side of an end of the fastener drive track 17. Referring to FIGS. 10 and 11, when long fastener 71 is received in the fastener drive track 17, the contact portion 92 is pushed by a connecting belt 710 of the long fastener 71 such that the stop portion 91 exits from the fastener drive track 17. As a result, referring to FIG. 12, the head 711 of the long fastener 71 won't hit the stop portion 91 when the long fastener 71 is driven.

The connecting belt 710 is configured for assembling a number of long fasteners 71 to obtain a fastener chain.

The feed track 701 is defined in the magazine assembly 70 and is aligned with the feed groove 172. The feed track 701 is configured for allowing fasteners received in the magazine assembly 70 to enter the fastener drive track.

Referring to FIGS. 19 and 20, an elastic member 90 is installed between the two swinging members 9 such that the swinging members 9 are elastically disposed at a corresponding side of the fastener drive track 17. The elastic member 90 applies an elastic force to the stop portion 91 of the swinging member 9 to enter the fastener drive track 17. The stop portion is arranged at a predetermined piston such that the head 721 of the short fastener 72 is exposed from the drive track exit 12. Therefore, the short fastener 72 is positioned prior to be driven.

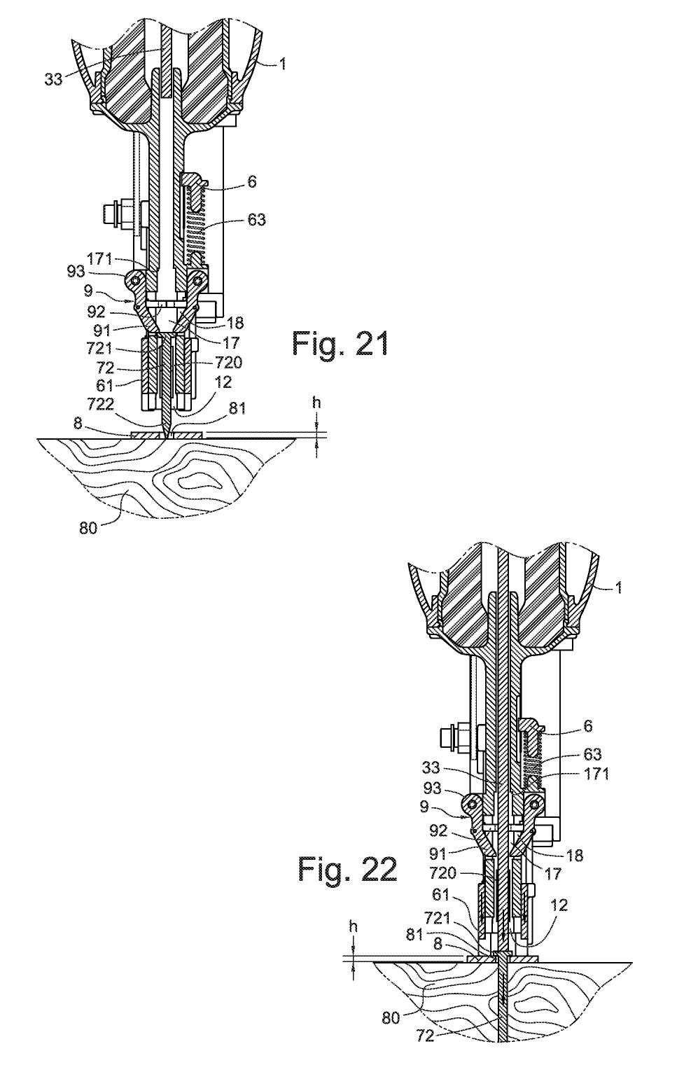

An end groove 18 is defined in the inner sidewall of the housing 1 (as shown in FIGS. 1, 1a, 5, 11, and 19). The end groove 18 is near to the swinging member 9 and is in communication with the feed track 701. The end groove 18 is also opposite to the stop portion 91 and the contact portion 92. The stop portion 91 can passes through the end groove 18 and enters the fastener drive track 17 or exit from the fastener drive track 17 through the end groove 18 (referring to FIG. 21). The contact portion 92 extends through the end groove 18 and reaches into the feed track 701 (referring to FIGS. 10, 20 and 21). Alternatively, two opposite end grooves 18a, 18b (referring to FIG. 5a) are defined in the inner sidewall of the housing 1. The end groove 18a is connected to the fastener drive track 17, and the end groove 18b is connected to the feed track 701. The stop portion 91 can pass through the end groove 18a and enter the fastener drive track 17 or exit from the fastener drive track 17 through the end groove 18a. The contact portion 92 extends through the end groove 18b and reaches into the feed track 701.

A mounting portion 93 is formed at another end (for example, the end opposite to the stop portion 91) of the swinging member 9 (referring to FIGS. 1, 1s, 2, 2a and 11). The mounting portion 93 is configured for pivotably mounting the swinging member 9 on a side of the fastener drive track 17. The contact portion 93 is arranged between the mounting portion 93 and the stop portion 91.

A lug portion 94 that is near to the stop portion 91 is formed on the swinging member 9 (as shown in FIGS. 1, 1a, 2, 2a and 10). The lug portion 94 gets in contact with the outer sidewall of the housing 1 when the stop portion 91 is received in the fastener drive track 17 (as shown FIG. 20). Thus, a position of the stop portion 91 in the fastener drive track 17 can be controlled. As a result, the stop portion 91 is protected from being hit by the drive rod 33 (as shown in FIG. 22).

The elastic member 90 can be an “n” shaped spring with its two ends pivotably disposed between the stop portion 91 and the mounting portion 93 of a respective swinging member 9.

Based upon above description, the using status of the present fastener positioning assembly will be described in detail accompany with FIGS. 11 through 18 as flowing:

When a user want to join a workpiece 8 to a object 80 with a long fastener 71 using a nailer, firstly, he can place the tip 712 of the long fastener 71 that is exposed from drive track exit 12 in a through hole 81 preformed in the workpiece 8 such that the tip 712 is in contact with the object 80 (as shown 11), the head 711 of the long fastener 71 is withstand by the step portion 171, thus, the long fastener 71 can't retract back into the fastener drive track 17. As a same time, the positioning member 61 is above the workpiece 8. Referring to FIG. 13, the trigger valve 4 is switched to an open state when the trigger 44 is triggered by the user, the pressurized air in the reservoir 10 passes through the air passageway 45, the fore-end passageway 111 and finally enters the air inlet 51 to press the contact end surface 541. The valve stem 54 is driven to move downwardly and the top end 62 of the safety rod 6 is driven by the contact surface 540. The safety rod 6 moves downwardly and the positioning member 61 is hanged above the object 80 at a predetermined height h (as shown in FIG. 11a) such that the positioning member 61 is in contact with the workpiece 8. The height h can be the thickness of the workpiece 8 or the depth of the through hole 81. The position of the hole 530 in the neck hole 531 and relative position of the valve plug 542 are designed according the height h. As such, the depth of the through hole 81 is reflected by the relative distance between the tip 712 of the long fastener 71 and the bottom surface of the positioning member 61, when the depth of the through hole 81 fit the predetermined height h, the valve stem 54 is supported by the safety rod 6, the valve plug enters the neck hole 531 that is below the hole 530, as a result, the air inlet 51 is connected to the vent hole 52, the air inlet 51 is separated from the lower chamber 56, the control valve 5 is opened, the pressurized air is conducted into the back-end passageway 112 and the main chamber 24 of the main valve (as shown in FIG. 14). The pressurized air in the main chamber 24 drives the lower valve portion 23 to move upwardly thereby opening the holes 21 and elevating the upper valve portion 25. The upper valve portion 25 closes the vent passageway 27, the pressurized air in the reservoir passes through the holes and enters the upper cylinder chamber 31. The pressurized air drives the drive rod 33 to move downwardly at a high speed thereby driving the long fastener 71. The long fastener 71 passes through the through hole 81 and joins the workpiece 8 on the object 80 (as shown in FIG. 12). When the piston 30 moves downwardly, a proportion of air in the lower cylinder chamber 32 enters the back air chamber 15 through the holes 34 and air via holes formed in the sidewall of lower cylinder chamber 32 above the holes 34, and the other gas goes into outer atmosphere though the vent hole 16. The stop portion 91 of the swinging member 9 has exited from the fastener drive track 17, therefore, the swinging member 9 won't be hit by the drive rod 33 when the drive rod 33 moves downwardly.

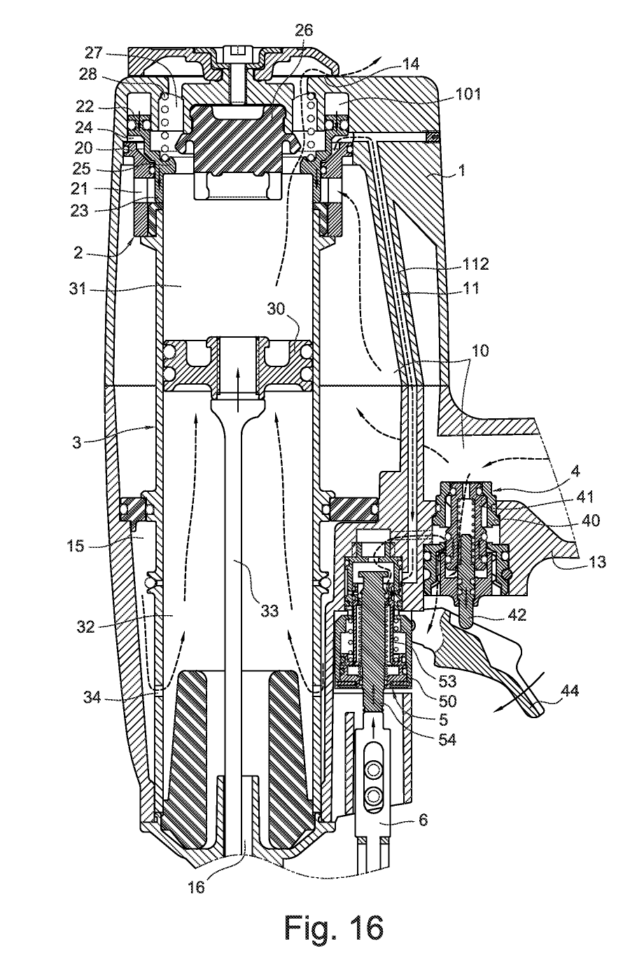

Referring to FIG. 15, when the trigger 44 is released by the user, the pressurized air in the reservoir 10 elevates the poppet 41, as a result, the air passageway 45 is closed and the vent passageway 46 is opened, the main passageway 11, the control valve 5 and the main chamber 24 are isolated from the reservoir 10, in addition, the pressurized air in the main chamber 24, main passageway 11 and the control valve 5 exit therefrom though the vent passageway 46. The pressurized air stored in the upper chamber 101 presses the valve bush 22 to descend thereby causing the lower valve portion 23 closes the holes 21 (as shown in FIG. 16) and the upper valve portion 25 opens the vent passageway 27, the remained air in the upper cylinder chamber 31 goes into outer atmosphere through the vent passageway 27 and the vent hole 14. During this period, the air stored in the back air chamber 15 passes through the lower cylinder chamber 32 and drives the piston 30 go back to its original position.

In addition, if the thickness of the workpiece 8 or the depth of the through hole 81 is larger than the predetermined height h, the displacement of the safety rod 6 will be reduced. In such circumstance, referring to FIG. 17, when the trigger 44 is triggered by the user, the trigger valve 4 is closed. The pressurized air in the reservoir 10 also passes through the gas passageway 45 and the fore-end passageway 111 and enters the air inlet 51. The pressurized air pushes the valve stem 54 to descend such that the positioning member 61 of the safety rod 6 is sustained by the workpiece while the positioning member 61 doesn't reach predetermined height h. At a same time, the valve stem 54 is supported by the safety rod. The valve plug 542 moves into the neck hole 531 and is above the hole 530. The air inlet 51 is isolated from the air outlet 52 and the lower chamber 56. The control valve 5 and the main passageway 11 are close. That is, the nailer is braked and the drive rod 33 won't drive the long fastener 72.

In addition, if the thickness of the workpiece 8 or the depth of the through hole 81 is less than the predetermined height h, the displacement of the safety rod 6 will be increased; in such circumstance, referring to FIG. 18, when the trigger 44 is pressed, the pressurized air in the reservoir 10 passes through the fore-end passageway 111, the air passageway 45, and finally enters the air inlet 51 to drive the valve stem 54 and the safety rod 6 to descend. The positioning member 61 exceeds the position of predetermined height h. The valve plug 542 slides into the through hole 532 thereby connecting the air inlet 51 to the neck hole 531, the through hole 532 and the lower chamber 56. The pressurized air enters the lower chamber 56 to drive the valve bush 53 to elevate. As a result, the air inlet 51 and the hole 530 are isolate from the air outlet 52, and the control valve 5 is closed. That is, the main passageway 11 is also closed. The drive rod 33 is braked. Simultaneously, the air outlet 52 and the middle chamber 58 are connected to the vent hole 59; the remained air in the main chamber 24 is vented through the back-end passageway 112, the annular chamber 57, the air outlet 52, the middle chamber 58 and the vent hole 59. Thus, the valve 23 won't be opened. If the user try to directly push the long fastener 71 into the object 80, the positioning member 61 of the safety rod 6 will exceed the position of the predetermined height h; in the other case, if the trigger 44 is triggered by a mistake and there is no object for sustaining the positioning member 61, the safety rod 6 will also exceed the position of the predetermined height h. In these circumstances, the valve stem 54 descends together with safety rod 6, and the valve plug 542 is received in the through hole 532, as a result, the drive rod 33 is thereby braked.

If the user try to join the workpiece 8 on the object 8 with a short fastener 72 using the same nailer, referring to FIGS. 19 and 21, the contact portion 92 of the swinging member 9 can't be supported by the connecting belt 70 of the short fastener 72 that is disposed in the feed track 701. Thus, the elastic force provided by the elastic member 90 drives the stop portion 91 to enter the fastener drive track 17 to the moment that the stop portion 91 is in contact with the head 721 of the short fastener 72. As such, the user can place the tip 722, which is exposed from the drive track exit 12 and the positioning member 61, of the short fastener 72 in the through hole 81. The tip 722 is in contact with the surface of the object 80. Because the head 721 of the short fastener 72 is sustained by the two stop potions 91, therefore, the short fastener 72 can't retract back into the fastener drive track 17. Referring to FIG. 22, when the trigger 44 is triggered so as to open the trigger valve 4, the piston 30 will drive the drive rod 33 to move downwardly at a high speed. As a result, the short fastener 72 passes through the through hole 81 thereby joining the workpiece 8 on the object 80. As shown in FIGS. 20 and 22, the stop portion 91 has exited from the fastener drive track 17 while the drive rod 33 is hitting the head 721 of the short fastener 72. Thus, the drive rod 33 won't hit the stop portions 91. The other operation procedure of driving short fastener 72 is similar to that described above accompanying with FIGS. 13 to 18.

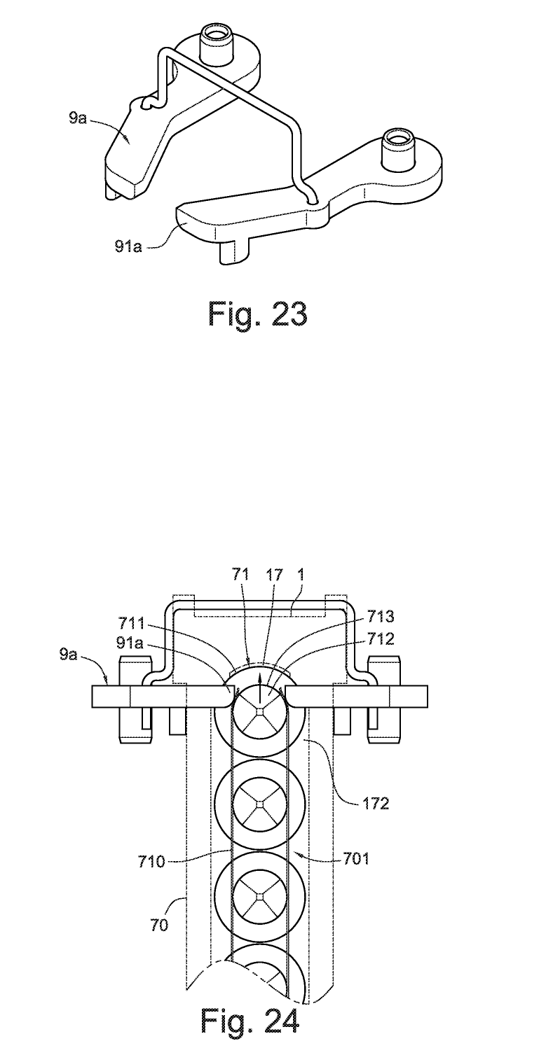

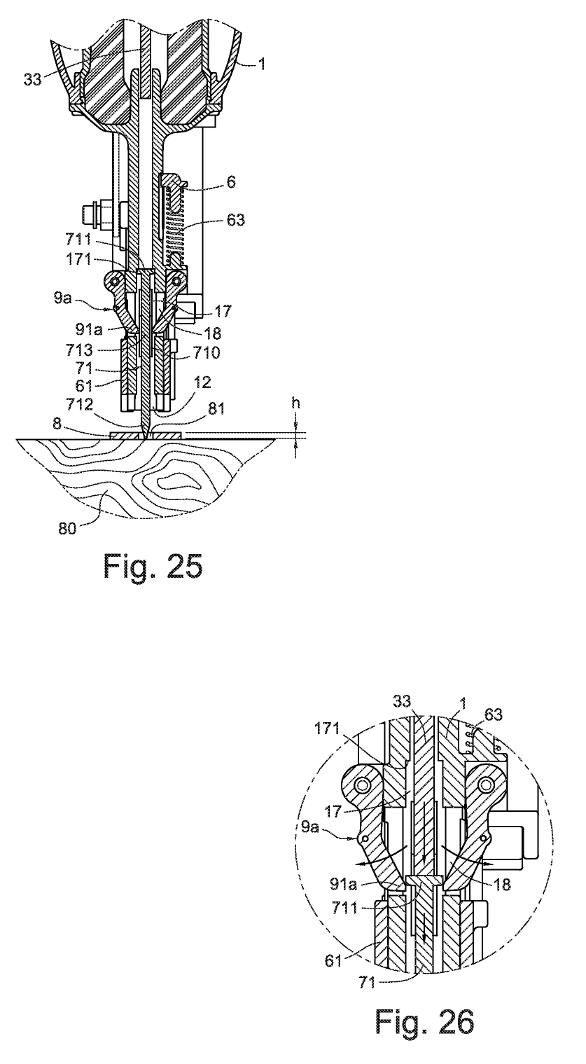

Referring to FIGS. 23 and 24, a swinging member 9a in accordance with a second embodiment is similar to the swinging member 9 except that the swinging member 9a hasn't the contact portion. As shown in FIG. 25, a shank 713 of the long fastener 71 can be received in the fastener drive track 17 and driven by the drive rod 33 without being blocked by the two stop portions 91a. Referring to FIG. 26, when the long fastener 71 is driven by the drive rod 33, the head 711 of the short fastener 71 hit the stop portions 91a of the swinging member 9a, the stop portion 91a swings to the end groove 18, the long fastener 71 and the drive rod 33 can feely passes through the fastener drive track 17.

As mentioned above, the fastener positioning assembly detects the thickness of the workpiece 8 or depth of the through hole 81 using the positioning member 61 of the safety rod 6, the control valve 5 controls opening and closing of the main passageway 11 according to position of the valve stem 54 that reflects the height of the safety rod 6.

In addition, when short fastener 72 is received in the fastener drive track 17, the shot fastener 72 can be positioned such that the tip 722 thereof is exposed from the drive track exit 12, the short fastener 72 can be also driven by the nailer. Thus, it is very convenient that the nailer can selectively use different fasteners according to different requirements.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A fastener positioning assembly for being installed on a housing of a nail gun, the nail gun comprising a fastener drive track capable of receiving fasteners having different length, wherein the faster positioning assembly further comprises:
at least one swing member elastically and pivotably disposed at a side of the fastener drive track; and
a stop portion defined at an end of the swing member and received in the fastener drive track, wherein the stop portion is configured for positioning fasteners prior to the fasteners are driven, and the stop portion retractably exits from the fastener drive track when longer fasteners are received in the fastener drive track.

2. The fastener positioning assembly as claimed in claim 1, further comprising two swinging members respectively pivotably disposed at two opposite sides of the fastener drive track, an elastic member connecting the two swinging members to each other, the elastic member providing an elastic force for driving the stop portion to enter the fastener drive track.

3. The fastener positioning assembly as claimed in claim 1, wherein an end groove is defined in an end of the housing that is adjacent to the swinging member, the end groove is connected to the fastener drive track and opposite to the stop portion, and the end groove is configured for allowing the stop portion retractably exiting therefrom.

4. The fastener positioning assembly as claimed in claim 1, wherein a lug portion is formed on the swinging member, the lug portion is adjacent to the stop portion, and the lug portion is configured for sustaining on the housing when the stop portion is received in the fastener drive track thereby controlling a depth of the stop portion in the fastener drive track.

5. A fastener positioning assembly for being installed on a housing of a nail gun, the nail gun comprising a fastener drive track capable of receiving fasteners having different length, wherein the faster positioning assembly further comprises:
at least one swing member elastically and pivotably disposed at a side of the fastener drive track;
a stop portion defined at an end of the swing member and received in the fastener drive track, wherein the stop portion is configured for positioning fasteners prior to the fasteners are driven, and the stop portion retractably exit from the fastener drive track when longer fasteners are received in the fastener drive track; and
a contact portion formed on another end of the swinging member, wherein the contact portion extends into a feed track disposed at a side of the fastener drive track, the contact portion is configured for driving the stop portion to retractably exits from the fastener drive track when the fasteners are driven.

6. The fastener positioning assembly as claimed in claim 5, wherein an end groove is defined in an end of the housing that is adjacent to the swinging member, the end groove is connected to the feed track and opposite to the contact portion; the contact passes through the end groove and enters the feed track.

7. The fastener positioning assembly as claimed in claim 5, wherein the swinging member comprises a connecting portion configured for pivotably mounting the swinging member at the side of the fastener drive track, the contact portion is arranged between the connecting portion and the stop portion.
